(19) United States
(12) Patent Application Publication
(10) Pub. No.: US 2014/0092591 A1
(43) Pub. Date: Apr. 3, 2014

(54) PATIO LIGHT

(71) Applicants: Cheih Oh Yang, (US); Wei Ou Yang, (US); JIANGSU SUN & MOON LIGHTING CO.,LTD., Yancheng City (CN)

(72) Inventors: CHIEH OU YANG, New Taipei City (TW); WEI OU YANG, Taipei City (TW)

(73) Assignee: JIANGSU SUN & MOON LIGHTING CO.,LTD., Yancheng city (CN)

(21) Appl. No.: 13/846,764

(22) Filed: Mar. 18, 2013

(30) Foreign Application Priority Data
Sep. 29, 2012 (CN) 201220507353.7

(51) Int. Cl. F21V 14/06

(52) U.S. Cl. CPC F21V 14/06
USPC 362/187; 362/277

(57) ABSTRACT

An approach is provided for a patio light, which comprises a main body, a lighting source, a Fresnel lens and a focusing adjuster. The lighting source is mounted on an anterior end of the main body. The Fresnel lens is disposed on an anterior end of the lighting source. The focusing adjuster is disposed on the main body and being used to adjust a distance between the Fresnel lens and the lighting source. Therefore, the patio light of the present invention has a zooming function and has benefit of reducing glare problem.

### FIELD OF THE INVENTION

Embodiments of the present invention relate to a patio light, particular to a patio light with a zooming function.

### BACKGROUND

A conventional patio light comprises a head, a base for heat consumption, a lighting source and a reflective cap. The lighting source comprises a light emitting diode (LED) plate and an LED lamp. The reflective cap is disposed on the lighting source to adjust the lighting distribution of the patio light.

Thus, in order to achieve different requirements, a seller has to prepare different patio lights with varied lighting distributions. However, not every order is actually adapted the each situation, a difference between the purchase and the sell will be occurred to introduce storage cost and a cash flow issue.

Otherwise, the conventional patio light uses the reflective cap to adjust the lighting angle that causes serious glare problem and brings asymmetrical lighting spot.

### SOME EXEMPLARY EMBODIMENTS

These and other needs are addressed by the present invention, wherein an approach is provided for a patio light that has a zooming function and reduces glare problem.

According to one aspect of an embodiment of the present invention, a patio light comprises a main body, a lighting source, a Fresnel lens and a focusing adjuster. The lighting source is mounted on an anterior end of the main body. The Fresnel lens is disposed on an anterior end of the lighting source. The focusing adjuster is disposed on the main body and being used to adjust a distance between the Fresnel lens and the lighting source.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is a cross sectioned view of an embodiment of a patio light in accordance with the present invention; and

FIG. 2 a cross sectioned view of another embodiment of a patio light in accordance with the present invention.

### DESCRIPTION OF THE PREFERRED EMBODIMENT

A patio light with a zooming function is disclosed. In the following description, for the purposes of explanation, numerous specific details are set forth in order to provide a thorough understanding of the present invention. It is apparent, however, to one skilled in the art that the invention may be practiced without specific details or with an equivalent arrangement. In other instances, well-known structures and devices are shown in block diagram form in order to avoid unnecessarily obscuring the embodiments of the present invention.

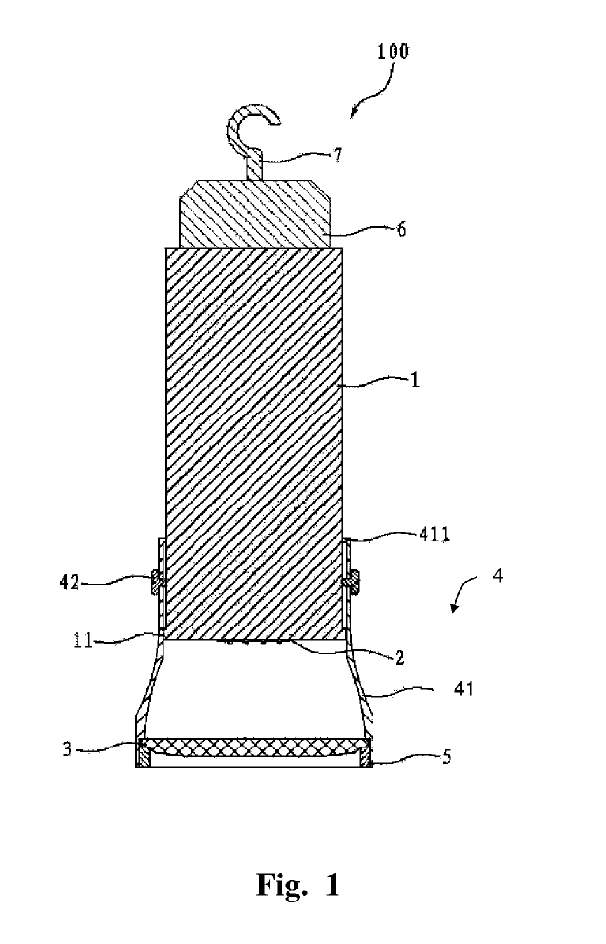

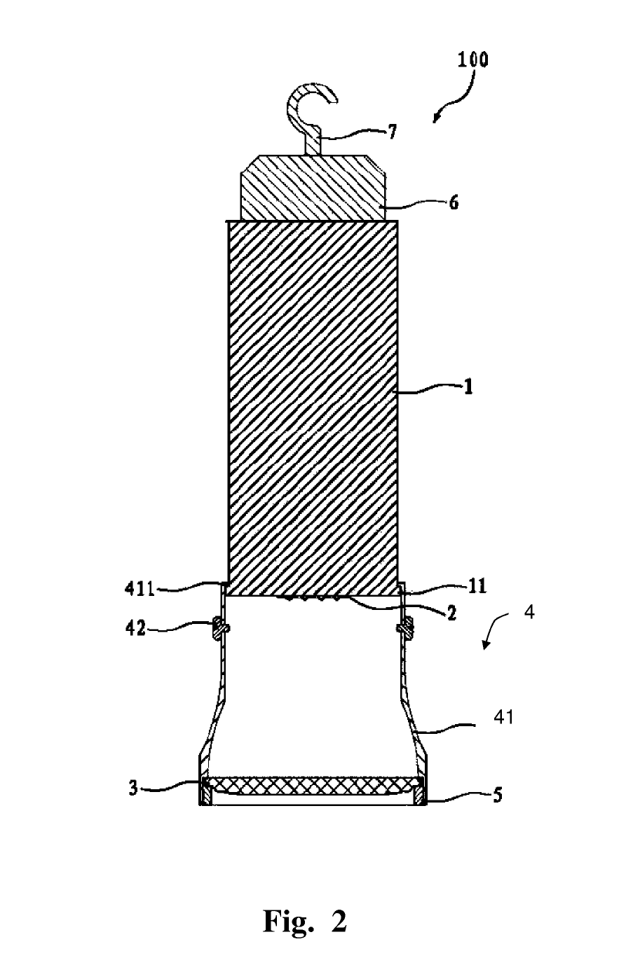

With reference to FIGS. 1 and 2, FIG. 1 is a cross sectioned view of an embodiment of a patio light in accordance with the present invention. FIG. 2 a cross sectioned view of another embodiment of a patio light in accordance with the present invention. The patio light 100 with a zooming function in accordance to the present invention comprises a main body 1, a lighting source 2, a Fresnel lens 3 and a focusing adjuster 4.

The lighting source 2 is mounted on an anterior end of the main body 1, and is any kind of lighting source, such as a light emitting diode (LED). The Fresnel lens 3 is disposed on an anterior end of the lighting source 2.

The focusing adjuster 4 is disposed on the main body 1, is used to adjust a distance between the Fresnel lens 3 and the lighting source 2 within an equivalent optical distance of the main body 1 and the Fresnel lens 3, which is 0˜2 times of focus of the Fresnel lens 3. The focusing adjuster 4 comprises a slide bushing 41 and a limiting knob 42. The slide bushing 41 has a posterior end that is slide along the main body 1 and an anterior end that is connected to the Fresnel lens 3. The limiting knob 42 positions the slide bushing 41 at a specific site of the main body 1. Therefore, the slide bushing 41 and the limiting knob 42 are used to adjust the distance between the lighting source 2 and the Fresnel lens 3 to perform variant lighting distribution and angle.

In order to prevent the slide bushing 41 moved out of the main body 1, the slide bushing 41 comprises a stop end 411 disposed on an anterior end of the of the slide bushing 41 and the main body 1 comprises a flange 11 disposed on a posterior end of the main body 1. The stop end 411 of the slide bushing 41 is against to the flange 11 of the main body 1. FIG. 2 discloses a largest distance of the lighting source 2 and the Fresnel lens 3.

Furthermore, in this embodiment, the Fresnel lens 3 is connected to the slide bushing 41 through a lens fastened ring 5.

The patio light 100 further comprises a power source 6 and a hook 7 that is disposed on the anterior end of the main body 1. The power source 6 applies the electricity for the patio light 100 operation. The hook 7 hangs the patio light 100 on the ceiling.

Accordingly, the focusing adjuster 4 enables the patio light 100 has broader distribution, lowers the requirement to consider about the actual height to hang the patio light 100 when purchasing the patio light 100 and reduces the storage amount and the cash flow to promote the patio light 100.

Moreover, the Fresnel lens 3 optically processes the light passed through the Fresnel lens 3 to reduce glare. The Fresnel lens 3 is further treated with a color spreading reagent to atomize or inside atomize the Fresnel lens 3 to form a firework surface to improve the spreading efficiency.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A patio light with a zooming functions comprising:
a main body;
a lighting source being mounted on an anterior end of the main body;
a Fresnel lens being disposed on an anterior end of the lighting source; and
a focusing adjuster being disposed on the main body and being used to adjust a distance between the Fresnel lens and the lighting source.

2. The patio light as claimed in claim 1, wherein the focusing adjuster comprises:
a slide bushing has a posterior end that is slide along the main body and an anterior end that is connected to the Fresnel lens; and
a limiting knob positions the slide bushing at a specific site of the main body.

3. The patio light as claimed in claim 2, wherein the slide bushing comprises a stop end disposed on an anterior end of the of the slide bushing and the main body comprises a flange disposed on a posterior end of the main body, the stop end of the slide bushing is against to the flange of the main body to prevent the slide bushing moved out of the flange of the main body.

4. The patio light as claimed in claim 2, wherein the Fresnel lens is connected to the slide bushing by a lens fastened ring.

5. The patio light as claimed in claim 1, wherein the patio light further comprises a power source and a hook that is disposed on the anterior end of the main body.

6. The patio light as claimed in claim 1, wherein the Fresnel lens is further treated with a color spreading reagent to atomize or inside atomize the Fresnel lens to form a firework surface.

7. The patio light as claimed in claim 1, wherein the distance between the Fresnel lens and the lighting source is within an equivalent optical distance of the main body and the Fresnel lens, which is 0˜2 times of focus of the Fresnel lens.
